(19) United States
(12) Patent Application Publication
(10) Pub. No.: US 2005/0152307 A1
(43) Pub. Date: Jul. 14, 2005

(54) Electronic sign-in board and method for facilitating use thereof

(76) Inventor: Ravi Oberoi, Orlando, FL (US)

Correspondence Address: Raymond M. Galasso;Simon, Galasso & Frantz PLC, P.O. Box 26503, Austin, TX, 78755-0503, US

(21) Appl. No.: 10/978,881

(22) Filed: Nov. 1, 2004

Related U.S. Application Data
(60) Provisional application No. 60/516,474, filed on Oct. 31, 2003.

(51) Int. Cl. H04Q 7/00

(52) U.S. Cl. 370/328

(57) ABSTRACT

A visitor sign-in device comprises memory and an electronic visitor sign-in form stored in the memory. The electronic visitor sign-in form designates sign-in information required from a visitor. The visitor sign-in device further comprises a visual display configured for enabling viewing of the electronic visitor sign-in form, means for facilitating input of sign-in information by the visitor, and means for transmitting the visitor sign-in information from the visitor sign-in device for reception by a sign-in information processing apparatus. The means for transmitting includes a transmission device configured for facilitating the transmitting in a wireless manner. The means for facilitating input includes at least one of at least one button, a touch screen overlying the visual display and means for enabling interpretation of handwritten responses by the visitor.

### CROSS REFERENCE TO RELATED APPLICATIONS

This application claims priority to co-pending U.S. Provisional Patent Application having Ser. No. 60/516,474 filed Oct. 31, 2003 entitled “Electronic Sign In Board (ESB)”, having a common applicant herewith.

### FIELD OF THE DISCLOSURE

The disclosures made herein relate generally to data processing systems and computer systems and, more particularly, to apparatuses configured for electronically gathering and processing sign-in information for a visitor to a business establishment.

### BACKGROUND

In various instances, visitors to a business establishment are often required to provide sign-in information at the inception of a visit. Examples of such visitors and respective visits include, but are not limited to, patients visiting a practitioner (e.g., a doctor, a dentist, a chiropractor, etc), a business person arriving for a meeting, a patron arriving at a restaurant, a vehicle owner arriving for service of their vehicle, etc. The conventional approach for providing such sign-in information is the visitor manually writing required sign-in information on a pre-printed form. Quite often the form is provided to the client on a clipboard for simplifying a clipboard and the client uses the clipboard as a writing surface while filling out the form. Examples of such required information include, but are not limited to, visitor name, visitor address, visitor phone number, visitor's company name, purpose for the visit, personal/business identification number(s) (e.g., social security number), various account information (e.g., insurance information), etc.

However, conventional approaches for gathering such sign-in information have one or more drawbacks. One drawback is that private and/or sensitive information may be seen and obtained by an unauthorized and/or unintended party. Another drawback is that some visitors have poor handwriting, which makes their provided information hard to read and prone to error in its interpretation and/or transcription. Still another drawback is that provided information is often incomplete and/or inaccurate, which can lead to wasted time in completing and/or correcting the provided information or adverse situations arising therefrom.

Therefore, equipment and methods configured for overcoming the drawbacks of such conventional approaches for providing sign-in information would be useful, advantageous and novel.

### SUMMARY OF THE DISCLOSURE

In one embodiment of the inventive disclosures made herein, a visitor sign-in apparatus comprises memory and an electronic visitor sign-in form stored in the memory. The electronic visitor sign-in form designates sign-in information required from a visitor. The visitor sign-in device further comprises a visual display configured for enabling viewing of the electronic visitor sign-in form and means for facilitating input of sign-in information by the visitor.

In another embodiment, a method for gathering visitor sign-in information comprises displaying an electronic visitor sign-in form on a visual display of a visitor sign-in device. The electronic visitor sign-in form designates sign-in information required from a visitor. After displaying the electronic visitor sign-in form, input of the sign-in information of the visitor is facilitated, followed by transmitting the visitor sign-in information from the visitor sign-in device for reception by a sign-in information processing apparatus.

In another embodiment, a visitor sign-in system comprises at least one data processing device, instructions processable by the at least one data processing device and an apparatus from which the instructions are accessible by the at least one data processing device. The instructions are configured for enabling the at least one data processing device to facilitate displaying an electronic visitor sign-in form on a visual display of a visitor sign-in device. The electronic visitor sign-in form designates sign-in information required from a visitor. The instructions are further configured for facilitating input of the sign-in information of the visitor and transmitting the visitor sign-in information from the visitor sign-in device for reception by a sign-in information processing apparatus.

Correspondingly, embodiments of sign-in equipment and associated methods in accordance with the inventive disclosures made herein allow visitor sign-in information to be gathered in a beneficial and advantageous manner with respect to conventional approaches. More specifically, such sign-in equipment and methods allow visitor sign-in information to be gathered accurately, completely and conveniently. Accordingly, services and meeting for which the visitors are signing in can be facilitated in a more accurate, complete, private and secure manner.

Turning now to specific embodiments of the inventive disclosures made herein, in at least one embodiment of the inventive disclosures made herein, means is provided for transmitting the visitor sign-in information from the visitor sign-in device for reception by a sign-in information processing apparatus.

In at least one embodiment of the inventive disclosures made herein, the means for transmitting includes a transmission device configured for facilitating the transmitting in a wireless manner.

In at least one embodiment of the inventive disclosures made herein, the means for facilitating input includes at least one button, a touch screen overlying the visual display and/or means for enabling interpretation of handwritten responses by the visitor.

In at least one embodiment of the inventive disclosures made herein, the electronic visitor sign-in form includes a plurality of selectable response options designating the sign-in information and/or a plurality of handwritten response fields designating the sign-in information.

In at least one embodiment of the inventive disclosures made herein, the transmitting includes transmitting entered portions of the sign-in information incrementally in concert with the sign-in information being entered by the visitor or transmitting the sign-in information in its entirety after all of the sign-in information is entered by the visitor.

In at least one embodiment of the inventive disclosures made herein, functionality of the sign-in device and/or the sign-in information processing apparatus includes facilitating checking the sign-in information for completeness, checking the sign-in information for accuracy and/or issuing an information re-entry notification.

In at least one embodiment of the inventive disclosures made herein, the electronic visitor sign-in form includes a first portion and a second portion and functionality of the sign-in device and the sign-in information processing apparatus includes determining content of the second portion of the sign-in form dependent upon sign-in information provided for the first portion of the sign-in form.

In at least one embodiment of the inventive disclosures made herein, the electronic visitor sign-in form is transmitted from the sign-in information processing apparatus for reception by the visitor sign-in device.

In at least one embodiment of the inventive disclosures made herein, the sign-in information processing apparatus facilitates processing of the visitor sign-in information in response to the visitor sign-in information being received by the sign-in information processing apparatus.

In at least one embodiment of the inventive disclosures made herein, the visitor sign-in device is a handheld visitor sign-in device.

These and other objects and embodiments of the inventive disclosures made herein will become readily apparent upon further review of the following specification and associated drawings.

### BRIEF DESCRIPTION OF THE DRAWING FIGURES

FIG. 1 depicts an embodiment of a visitor sign-in system in accordance with an embodiment of the inventive disclosures made herein.

FIG. 2 depicts an embodiment of a method configured for gathering and processing visitor sign-in information in accordance with the inventive disclosures made herein.

### DETAILED DESCRIPTION OF THE DRAWING FIGURES

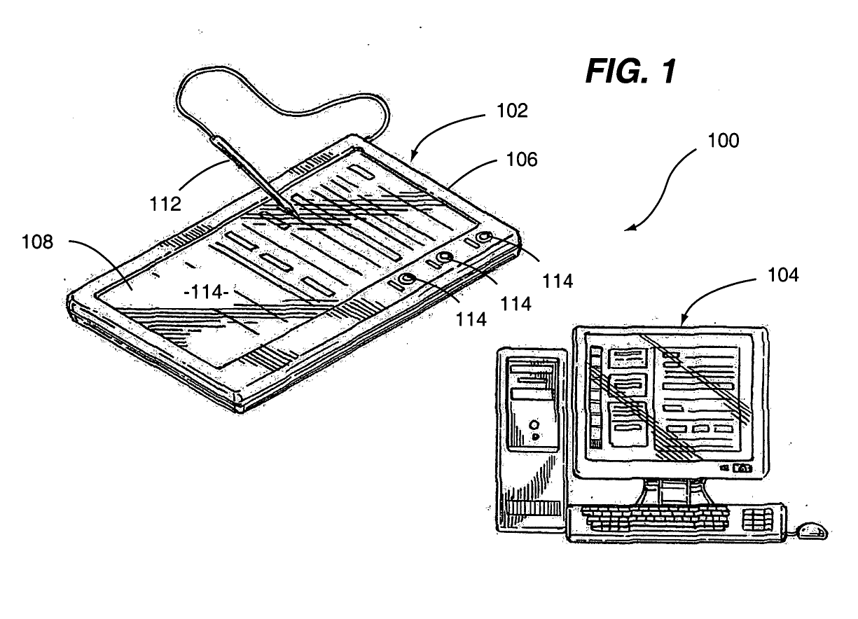

FIG. 1 depicts an embodiment of a visitor sign-in system 100 in accordance with an embodiment of the inventive disclosures made herein. The visitor sign-in system 100 includes a visitor sign-in device 102 and a sign-in information processing apparatus 104. The visitor sign-in device 102 communicates with the sign-in information processing apparatus 104 for enabling sign-in information to be gathered accurately, completely, conveniently and privately. In one specific embodiment, the visitor sign-in device 102 communicates with the sign-in information processing apparatus 104 in a wireless manner and the visitor sign-in device 102 is preferably configured for being handheld. In other embodiments, the visitor sign-in device 102 communicates with the sign-in information processing apparatus 104 via a hardwired connection and is preferably configured for being mounted to a fixed surface.

The visitor sign-in device 102 includes a plurality of interconnected components (not all of which are specifically depicted) configured for enabling communication with the sign-in information processing apparatus 104 and for facilitating input of visitor sign-in information by a visitor. The plurality of interconnected components are housed in a housing 106. An electronic visitor sign-in form is, for example, stored in memory of the visitor sign-in device 102 and designates sign-in information required from a visitor. A visual display 108 (e.g., a liquid crystal display) is configured for enabling viewing of the electronic visitor sign-in form (i.e., generally depicted as electronic visitor sign-in form 110 on visual display 108).

The visitor sign-in device 102 includes various means for facilitating input of the sign-in information by the visitor. Examples of such means for facilitating input include a tethered stylus 112, a touch screen overlying the visual display 108, a plurality of buttons 114 and means (e.g., logic and hardware components) for enabling interpretation of handwritten responses by the visitor. Other configurations and combinations of such means for facilitating input will be appreciated in view of the inventive disclosures made herein.

The visitor sign-in device 102 and the sign-in information processing apparatus 104 are jointly configured for enabling communication of information therebetween. More specifically, the visitor sign-in device 102 includes means for transmitting information (e.g., the visitor sign-in information) from the visitor sign-in device 102 for reception by the sign-in information processing apparatus 104. Similarly, the sign-in information processing apparatus 104 includes means for transmitting information (e.g., the visitor sign-in form) from the sign-in information processing apparatus 104 for reception by the visitor sign-in device 102. Examples of such means include known and/or commercially available network interface devices, radio transceivers, antennas, and the like.

In one embodiment, the electronic visitor sign-in form 110 includes a plurality of selectable response options designating the sign-in information and/or a plurality of handwritten response fields designating the sign-in information. An example of such selectable response options includes displayed, selectable buttons corresponding to respective response options. An example of such handwritten response fields includes a field that is configured for having a handwritten response written therein (e.g., via the stylus and means for enabling interpretation of handwritten responses). Examples of response information include, but are not limited to, visitor name, visitor address, visitor phone number, visitor's company name, purpose for the visit, personal/business identification number(s) (e.g., social security number), various account information (e.g., insurance information), etc.

In one embodiment of the inventive disclosures made herein, the sign-in information processing apparatus 104 is preferably a data processing apparatus such as a server and the handheld sign-in device 102 is a client device that is served information from the sign-in information processing apparatus 104. In another embodiment, the sign-in information processing apparatus 104 and the handheld sign-in device are both standalone data processing apparatuses that have respective centralized processing functionality and capability. Accordingly, the handheld sign-in device 102 and the sign-in information processing apparatus 104 are jointly configured with respective hardware and software components. These hardware and software components (generally referred to as components) are jointly and/or separately configured for facilitating gathering and processing of visitor sign-in information in accordance with the inventive disclosures made herein. In addition to conventional and/or known components of a data processing apparatus (e.g., conventional components for processing information, enabling viewing and manipulation of information, transmitting information and the like), components specific to visitor sign-in information functionality in accordance with the inventive disclosures made herein are provided. Examples of such components specific to visitor sign-in information functionality include components configured for extracting visitor sign-in information form the electronic visitor sign-in form, components configured for checking the sign-in information for completeness, components configured for checking the sign-in information for accuracy, components configured for issuing an information re-entry notification to the visitor in response to an inaccuracy or incompleteness being identified and components configured for enabling manipulation of the extracted visitor sign-in information (e.g., enabling editing via the sign-in information processing apparatus).

In one specific embodiment, software is provided for providing visitor sign-in form information (i.e., information being requested of the visitor) dependent upon certain conditions. For example, the electronic visitor sign-in form includes a first portion and a second portion and the content of the second portion of the sign-in form is dependent upon sign-in information provided for the first portion of the sign-in form. In this example, visitor sign-in information (e.g., visitor name and doctor name) provided on a first portion of the visitor sign-in form causes the sign-in information processing apparatus 104 to prepare and serve to the handheld visitor sign-in device 102 a second portion of the visitor sign-in form. In this manner, the second portion of the form is intended to gather visitor sign-in information dependent upon the visitor sign-in information provided on the first portion of the visitor sign-in form (e.g., information specific to a particular type of visit). Accordingly, different visitors provide different type of information dependent upon details associated with their particular visit.

In other embodiments, the electronic sign-in form 110 is user selectable from a collection of available forms by the visitor and/or a system facilitator (e.g., lobby clerk).

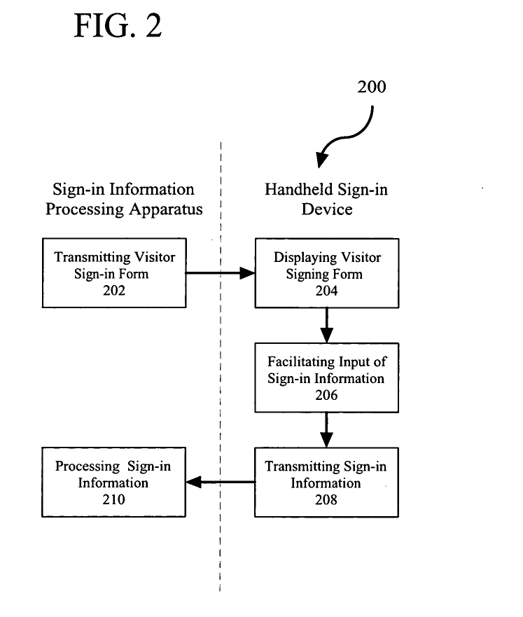

FIG. 2 depicts an embodiment of a method 200 configured for gathering and processing visitor sign-in information in accordance with the inventive disclosures made herein. An operation 202 is performed by a sign-in information processing apparatus (e.g., the sign-in information processing apparatus 104 discussed in reference to FIG. 1) for transmitting a visitor sign-in form for reception by a handheld sign-in device (e.g., the handheld visitor sign-in device 102 discussed in reference to FIG. 1). The electronic visitor sign-in form designates sign-in information required from a visitor. In one example, the transmitted form is non-specific to a particular type of visit (e.g., requesting general visitor sign-in information). In another example, the transmitted form is specific to a particular type of visit (e.g., requesting visitor sign-in information dependent upon details at least partially specific to the visitor).

After receiving the visitor sign-in form, the handheld sign-in device performs an operation 204 for displaying the visitor sign-in form (i.e., an electronic visitor sign-in form). In one example, the visitor sign-in form is displayed in response to the visitor sign-in form being received by the handheld sign-in device 102. In another embodiment, the visitor sign-in form is displayed after being received by the handheld sign-in device 102 and in response to a command by the visitor. Examples of such a command include, but are not limited to, the visitor picking up the device, the visitor selecting an on-screen selection, and/or the visitor pressing a designated button.

With the visitor sign-in form displayed, the handheld sign-in device performs an operation 206 for facilitating input of sign-in information by the visitor. Examples of facilitating input of the sign-in information include, but are not limited to, enabling handwritten responses, enabling selection of response selections, enabling response via selection of a button, and the like. In one embodiment of the inventive disclosures made herein, such facilitating includes notifying the visitor of incomplete information, missing information, inaccurate information and the like.

In response to all or a required portion of the sign-in information having been entered, the handheld sign-in device performs an operation 208 for transmitting the sign-in information for reception by the sign-in information processing apparatus. In one embodiment, entered portions of the sign-in information are transmitted incrementally (e.g., in prescribed segments) in concert with the sign-in information being entered by the visitor. In another embodiment, the sign-in information is transmitted in its entirety after all of the sign-in information is entered, which may be done in a manner that overwrites partial downloads of sign-in information (e.g., previously downloaded segments) that was previously transmitted in the incremental manner disclosed above.

After receiving the sign-in information, the sign-in information processing apparatus performs an operation 210 for processing the sign-in information. Examples of processing the sign-in information include, but are not limited to, extracting sign-in information from a file transmitted from the handheld sign-in device, populating an information management structure (e.g., a database or a spreadsheet) with all or a portion of the sign-in information, notifying the visitor of incomplete information, notifying the visitor of missing information, notifying the visitor of inaccurate information, confirming the visitor that the completed form was successfully received and the like.

It is disclosed herein that the handheld sign-in device may be configured for performing certain portions of the method 200 which are disclosed in FIG. 2 as being performed by the sign-in information professing apparatus. In one example, the electronic sign-in form or forms reside on the handheld sign-in device. In another example, all or a portion of processing of the sign-in information is performed by the handheld sign-in device (e.g., notifying the visitor of incomplete information, notifying the visitor of missing information, notifying the visitor of inaccurate information, confirming that the completed form was successfully received and the like). In still another example, the handheld sign-in device resets the electronic sign-in form after information input is completed (e.g., clearing entered information), thereby enabling a next visitor to enter his or her respective visitor sign-in information.

Referring now to computer readable medium, methods, processes and/or operations adapted for carrying out visitor sign-in functionality as disclosed herein are tangibly embodied by computer readable medium (e.g., a software product) having instructions thereon for carrying out such functionality. In one specific embodiment, the instructions are tangibly embodied for carrying out the method 200 disclosed above to facilitate such visitor sign-in functionality. The instructions may be accessible by one or more data processors (e.g., a data processor of the handheld sign-in device and/or the sign-in information processing apparatus) from a memory apparatus (e.g. RAM, ROM, virtual memory, hard drive memory, etc), from an apparatus readable by a drive unit (e.g., a diskette, a compact disk, a tape cartridge, etc) or both. Accordingly, embodiments of computer readable medium in accordance with the inventive disclosures made herein include a compact disk, a hard drive, RAM or other type of storage apparatus that has imaged thereon a computer program (i.e., a set of instructions) adapted for carrying out visitor sign-in functionality in accordance with the inventive disclosures made herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A visitor sign-in device, comprising:
memory;
an electronic visitor sign-in form stored in said memory, wherein the electronic visitor sign-in form designates sign-in information required from a visitor;
a visual display configured for enabling viewing of the electronic visitor sign-in form; and
means for facilitating input of said sign-in information by the visitor.

2. The device of claim 1, further comprising:
means for transmitting said visitor sign-in information from the visitor sign-in apparatus for reception by a sign-in information processing apparatus.

3. The device of claim 2 wherein said means for transmitting includes a transmission device configured for facilitating said transmitting in a wireless manner.

4. The device of claim 1 wherein said means for facilitating input includes at least one of at least one button, a touch screen overlying the visual display and means for enabling interpretation of handwritten responses by the visitor.

5. The device of claim 1 wherein the electronic visitor sign-in form includes at least one of a plurality of selectable response options designating said sign-in information and a plurality of handwritten response fields designating said sign-in information.

6. The device of claim 1, further comprising:
means for transmitting said visitor sign-in information from the visitor sign-in apparatus for reception by a sign-in information processing apparatus;
wherein said means for transmitting includes a transmission device configured for facilitating said transmitting in a wireless manner;
wherein said means for facilitating input includes at least one of at least one button, a touch screen overlying the visual display and means for enabling interpretation of handwritten responses by the visitor; and
wherein the electronic visitor sign-in form includes at least one of a plurality of selectable response options designating said sign-in information and a plurality of handwritten response fields designating said sign-in information.

7. The device of claim 1, further comprising:
at least one data processing device;
instructions processable by said at least one data processing device; and
an apparatus from which said instructions are accessible by said at least one data processing device;
wherein said instructions are configured for enabling said at least one data processing device to facilitate:
displaying the electronic visitor sign-in form on the visual display;
facilitating input of said sign-in information of the visitor; and
transmitting said visitor sign-in information from the visitor sign-in apparatus for reception by a sign-in information processing apparatus.

8. The device of claim 7 wherein said transmitting includes one of transmitting entered portions of said sign-in information incrementally in concert with said sign-in information being entered by the visitor and transmitting said sign-in information in its entirety after all of said sign-in information is entered.

9. The device of claim 7 wherein said instructions are configured for enabling said at least one data processing device to facilitate at least one of checking said sign-in information for completeness, checking said sign-in information for accuracy and issuing an information re-entry notification.

10. The device of claim 7 wherein:
the electronic visitor sign-in form includes a first portion and a second portion; and
said instructions are configured for enabling said at least one data processing device to facilitate determining content of the second portion of the sign-in form dependent upon sign-in information provided for the first portion of the sign-in form.

11. A method for gathering visitor sign-in information, comprising:
displaying an electronic visitor sign-in form on a visual display of a visitor sign-in apparatus, wherein the electronic visitor sign-in form designates sign-in information required from a visitor;
facilitating input of said sign-in information of the visitor; and
transmitting said visitor sign-in information from the visitor sign-in apparatus for reception by a sign-in information processing apparatus.

12. The method of claim 11, further comprising:
transmitting the electronic visitor sign-in form from the sign-in information processing apparatus for reception by the visitor sign-in device; and
processing said visitor sign-in information in response to said visitor sign-in information being received by the sign-in information processing apparatus, wherein said processing is performed by the sign-in information processing apparatus.

13. The method of claim 12 wherein said processing includes at least one of checking said sign-in information for completeness, checking said sign-in information for accuracy and issuing an information re-entry notification.

14. The method of claim 12 wherein:
the electronic visitor sign-in form includes a first portion and a second portion;
said transmitting visitor sign-in information includes transmitting sign-in information corresponding to the first portion of the electronic visitor sign-in form; and
said processing includes determining content of the second portion of the sign-in form dependent upon sign-in information provided for the first portion of the sign-in form and initiating transmission of the second portion of the electronic visitor sign-in form for reception by the sign-in device.

15. The method of claim 11 wherein said transmitting includes one of transmitting entered portions of said sign-in information incrementally in concert with said sign-in information being entered by the visitor and transmitting said sign-in information in its entirety after all of said sign-in information is entered.

16. A visitor sign-in system, comprising:
at least one data processing device;
instructions processable by said at least one data processing device; and
an apparatus from which said instructions are accessible by said at least one data processing device;
wherein said instructions are configured for enabling said at least one data processing device to facilitate:
displaying an electronic visitor sign-in form on a visual display of a visitor sign-in device, wherein the electronic visitor sign-in form designates sign-in information required from a visitor;
facilitating input of said sign-in information of the visitor; and
transmitting said visitor sign-in information from the visitor sign-in device for reception by a sign-in information processing apparatus.

17. The system of claim 16 wherein said instructions are further configured for
enabling said at least one data processing device to facilitate:
transmitting the electronic visitor sign-in form from the sign-in information processing apparatus for reception by the visitor sign-in device; and
processing said visitor sign-in information in response to said visitor sign-in information being received by the sign-in information processing apparatus, wherein said processing is performed by the sign-in information processing apparatus.

18. The system of claim 17 wherein said processing includes at least one of checking said sign-in information for completeness, checking said sign-in information for accuracy and issuing an information re-entry notification.

19. The system of claim 17 wherein:
the electronic visitor sign-in form includes a first portion and a second portion;
said transmitting visitor sign-in information includes transmitting sign-in information corresponding to the first portion of the electronic visitor sign-in form; and
said processing includes determining content of the second portion of the sign-in form dependent upon sign-in information provided for the first portion of the sign-in form and initiating transmission of the second portion of the electronic visitor sign-in form for reception by the sign-in device.

20. The system of claim 16 said transmitting includes one of transmitting entered portions of said sign-in information incrementally in concert with said sign-in information being entered by the visitor and transmitting said sign-in information in its entirety after all of said sign-in information is entered.
